(19) United States
(12) Patent Application Publication
(10) Pub. No.: US 2025/0106202 A1
(43) Pub. Date: Mar. 27, 2025

(54) PROACTIVE ALERTS TO PREPARE A DEVICE TO ENABLE AN UPCOMING TWO-FACTOR AUTHENTICATION TRANSACTION

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN); HARIPRASAD SHANBHOGUE ALAMPADY, BANGALORE (IN)

(21) Appl. No.: 18/473,874

(22) Filed: Sep. 25, 2023

(51) Int. Cl. H04L 9/40

(52) U.S. Cl. CPC H04L 63/0853; H04L 63/0272; H04L 63/0838

(57) ABSTRACT

A method provides techniques for generating proactive alerts to prepare a device to enable an upcoming two-factor authentication (2FA) transaction. The method includes detecting, by an electronic device comprising a display, a potential two-factor authentication (2FA) condition. The method continues with detecting a 2FA readiness status of a receiving device to receive and present 2FA information. In response to identifying the 2FA readiness status of the receiving device as not ready, an alert is displayed on the display of the electronic device. Accordingly, disruptions and delays in transaction processing due to a receiving device not being ready for two-factor authentication are mitigated.

### BACKGROUND

### 1. Technical Field

The present disclosure generally relates to electronic devices, and more specifically to handling of two-factor authentication transactions completed via electronic devices.

### 2. Description of the Related Art

Smartphones have become an integral part of daily life and provide a wide range of functionality. This functionality can include communication via voice calls, text messages, and/or other messaging applications (apps). Other popular functions of smartphones include gaming, navigation, ecommerce, online banking, health and fitness tracking, and more.

One area of smartphone usage that has seen growth in recent years is online financial activities such as banking, stock trading, ecommerce, and other activities requiring secure online access. Fast and secure access to online accounts is essential for safeguarding personal, financial, and professional information. Techniques such as two-factor authentication (2FA) and/or multifactor authentication (MFA) help prevent unauthorized access, protect sensitive information, maintain privacy, and promote the continued availability of important services.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example component makeup of a communication device with specific components used to enable the device to prepare for an upcoming transaction requiring two-factor authentication, according to one or more embodiments;

FIG. 2A is a diagram illustrating an example of a flash sale offer;

FIG. 2B is a diagram illustrating an example of a two-factor authentication alert for the flash sale offer referenced in FIG. 2A, according to one or more embodiments;

FIG. 3 is a diagram illustrating an example of a notification presented on a second electronic device, to alert a user to ready a portable electronic communication device for completing a two-factor authentication, according to one or more embodiments;

FIG. 4 is a diagram illustrating an example of a notification presented on a second electronic device, to automatically enable a portable electronic communication device for two-factor authentication, according to one or more embodiments;

FIG. 5 is a diagram illustrating an example of retrieving a one-time passcode from a portable electronic communication device for use in two-factor authentication, according to one or more embodiments;

FIG. 6A is a diagram illustrating an example of sharing a secure uniform resource locator (URL) on a portable electronic communication device;

FIG. 6B is a diagram illustrating an example of providing an alert to a user to ready a portable communication device to provide two-factor authentication for VPN (virtual private network) access for the secure URL shown in FIG. 6A, according to one or more embodiments;

FIG. 7 depicts a flowchart of a method for generating alerts regarding a status of a portable communication device for enabling an upcoming two-factor authentication transaction at the portable communication device, according to one or more embodiments;

FIG. 8 depicts a flowchart of a method for checking if a network interface required for receiving two-factor authentication information is enabled, according to one or more embodiments;

FIG. 9 depicts a flowchart of a method for receiving a one-time passcode (OTP) from a second electronic communication device and displaying the OTP on a first electronic communication device, according to one or more embodiments;

FIG. 10 depicts a flowchart of a method for identifying a communication channel associated with a two-factor authentication method, based on a user profile, according to one or more embodiments;

FIG. 11 depicts a flowchart of a method for generating an alert based on checking a 2FA readiness status of a receiving device associated with a VPN, according to one or more embodiments; and

FIG. 12 depicts a flowchart of a method for indicating, within an alert, that a receiving device or an application required for two-factor authentication is unavailable, according to one or more embodiments.

### DETAILED DESCRIPTION

Disclosed embodiments mitigate the aforementioned problems by automatically enabling a 2FA receiving device and/or alerting a user that the 2FA receiving device needs to be enabled. According to aspects of the disclosure, an electronic (communication) device, a method, and a computer program product enable generation of early alerts regarding a 2FA readiness status of a communication device being used for completing an upcoming two-factor authentication transaction, according to one or more embodiments. In one or more embodiments, a ‘two-factor authentication transaction’ can include an online transaction that requires 2FA. Examples can include, but are not limited to, signing into an online bank account, logging on to a corporate intranet, accessing an ecommerce account, and so on. Aspects of the disclosure further enable automatic triggering of the communication device to modify device operating parameters to change the device from a not ready status to a ready status for 2FA. According to the disclosure, a potential two-factor authentication (2FA) condition is detected. The 2FA condition can include a condition in which a device is connected to a website typically associated with two-factor authentication, such as a banking, ecommerce, or other website that typically utilizes 2FA. A 2FA readiness status of a receiving device is detected. In response to identifying the 2FA readiness status of the receiving device as “not ready”, an alert indicating this not “ready” status is displayed on the display of the electronic device.

Throughout this disclosure, the terms ‘electronic device’, ‘communication device’, and ‘electronic communication device’ may be used interchangeably, and may refer to devices such as smartphones, tablet computers, and/or other computing/communication devices. Further, the device that is completing the underlying transaction or account access and performing the check of the 2FA readiness status can be a separate device from the communication device which receives the 2FA data to enable completion of the 2FA operation. However, one or more embodiments can provide a single device implementation in which a separate application (e.g., email or text message) operating on the same device as the device completing the transaction or account access can be offline, not active, in airplane mode, or in a do-not-disturb (DND) status, so as not to receive the 2FA. These embodiments then present the notification on the electronic device to alert the user of the non-ready status and trigger the user action to change the device's operating state or application status in order to receive the 2FA data. Alternatively, in an automated embodiment, the device processor can trigger a change in the operating status of the device relative to the not-ready state of the application. For example, the device can be switched from airplane mode to allow a text message with the 2FA data to be received by the device via the cellular communication network.

Two-factor authentication (2FA) is a security process that adds an extra layer of protection to online accounts and systems. Two-factor authentication can enhance the security of user accounts beyond just using a password. The main idea of 2FA is to require two different forms of identification before granting access to an account or system, making it significantly more difficult for unauthorized individuals to gain access. In many account-based systems, when two-factor authentication is enabled on an account, the system will require a user to provide two of these factors to verify the identity of the user. For example, when logging into an account with 2FA enabled, a user might enter a password and then receive a one-time passcode (OTP) on his/her mobile device, where the OTP also needs to be entered in order to gain access to the account. This 2FA process ensures that even if someone manages to obtain the password, that person will still not be able to access the user's account without the second factor, which can be an OTP.

The aforementioned features are well-suited for operations that are time sensitive and require two factor authentication for the operation to be completed. Examples of these operations include taking advantage of flash sales, making electronic payments for bills, or other time-bound operations where two-factor authentication may be required. In the case of a flash sale, a user may have a limited amount of time (e.g., five minutes) to take advantage of a sale for a given item. In an example where a user is attempting to complete the flash sale transaction on his/her laptop computer late at night, the user's mobile device associated with 2FA may be off, asleep, placed in a DND mode, or otherwise offline. In this example, a one-time passcode (OTP) that is needed for a 2FA process to complete the flash sale is being sent to the user's mobile device, which needs to be in a correct operating state to receive and provide the OTP. The user may proceed with the flash sale, and after attempting to purchase the item, realize that the mobile device is offline or not in proper operating state to timely present the OTP. The user may then have to enable the device and restart the purchase process. However, by that time, it may be too late, and the user may miss the flash sale (or other time-sensitive) opportunity.

Disclosed embodiments mitigate the aforementioned problems by detecting a possible need for two-factor authentication, and providing a reminder for the user to ensure their device is ready to receive 2FA information. The 2FA information can be delivered via text messages, automated voice calls, an authentication application, and/or other suitable techniques. The 2FA information may require a specific network interface (e.g., cellular network), and/or a WiFi network. Additionally, the 2FA information can be conveyed via an authenticator application, such as Microsoft Authenticator, Google Authenticator, or other suitable application.

Also, an increasingly large number of users use their mobile devices (e.g., smartphones, tablets, and the like) for financial operations such as ecommerce, banking, trading stocks and other securities, and so on. These activities often require two-factor authentication (2FA) to complete a transaction. Thus, two-factor authentication significantly improves the security of online accounts because 2FA adds an additional layer of complexity for potential attackers. Even if the malicious actors manage to obtain a password through phishing, data breaches, or other means, they would still need the second factor (e.g., the OTP) to gain access. This makes it much harder for unauthorized individuals to compromise user accounts. However, the added security can create additional inconvenience. As an example, if a user is trying to complete a transaction on a laptop computer that requires his mobile device to be connected to a cellular network in order to receive an OTP via text message, and his mobile device is in airplane mode, then the OTP cannot be received, and the transaction may need to be aborted and restarted. For a time-bound activity such as a flash sale, the abort and restart of the flash sale transaction may cause the user to miss the flash sale opportunity.

The disclosed embodiments mitigate the aforementioned problems by automatically enabling a 2FA receiving device and/or alerting a user that the 2FA receiving device needs to be enabled. This process allows a user to make sure the receiving device (and/or receiving application on the device) is ready before attempting to complete a transaction or other operation that requires 2FA. One or more embodiments provide an electronic device comprising: a display; a memory having stored thereon at least one application and a two-factor authentication readiness (2FAR) control module; a network interface which enables the electronic device to connect to, and exchange data with, at least one second electronic device; and a processor communicatively coupled to the display, the memory, and the network interface, and which executes program code of the 2FAR control module, which enables the electronic device to: detect a potential two-factor authentication (2FA) condition; detect a 2FA readiness status of a receiving device to receive and present 2FA information; and in response to identifying the 2FA readiness status of the receiving device as not ready, display an alert on the display of the electronic device. Accordingly, disclosed embodiments can streamline operations that require two-factor authentication.

The above descriptions contain simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

Each of the above and below described features and functions of the various different aspects, which are presented as operations performed by the processor(s) of the communication/electronic devices are also described as features and functions provided by a plurality of corresponding methods and computer program products, within the various different embodiments presented herein. In the embodiments presented as computer program products, the computer program product includes a non-transitory computer readable storage device having program instructions or code stored thereon, which enables the electronic device and/or host electronic device to complete the functionality of a respective one of the above-described processes when the program instructions or code are processed by at least one processor of the corresponding electronic/communication device, such as is described above.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one implementation (embodiment) of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not for other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element (e.g., a person or a device) from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

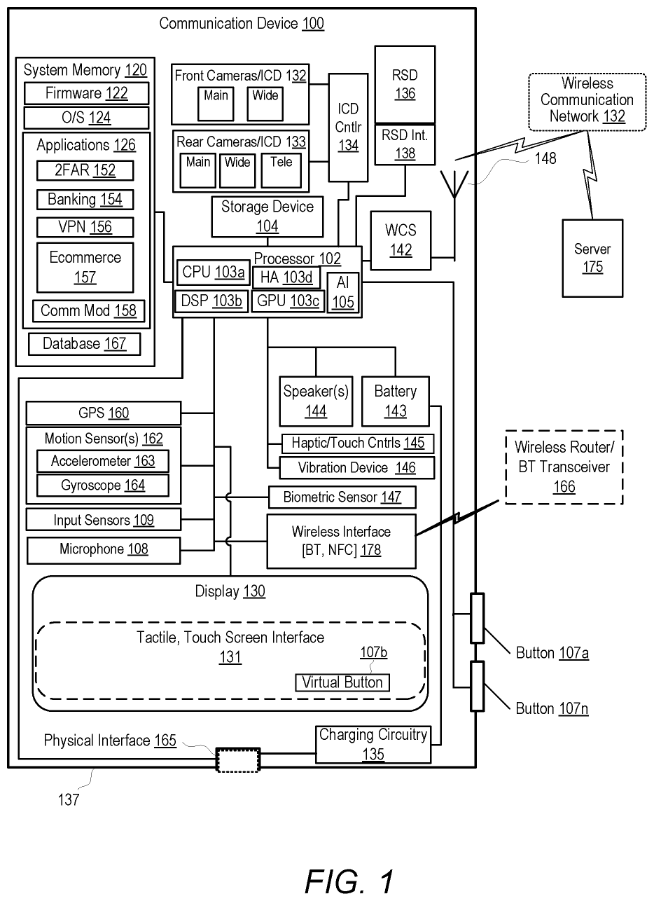

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

Referring now to the figures and beginning with FIG. 1, there is illustrated an example component makeup of electronic device 100, within which various aspects of the disclosure can be implemented, according to one or more embodiments. Electronic device 100 includes specific components used to enable the device to detect a potential 2FA condition, and to generate alerts and/or automatic enable a receiving device to receive 2FA information such as a one-time passcode (OTP). Examples of electronic device 100 include, but are not limited to, mobile devices, a notebook computer, a mobile phone, a smart phone, a digital camera with enhanced processing capabilities, a smart watch, a tablet computer, and other types of electronic device. It is appreciated that electronic device 100 can include other types of electronic devices that enable participation in a two-factor authentication process.

Electronic device 100 includes processor 102 (typically as a part of a processor integrated circuit (IC) chip), which includes processor resources such as central processing unit (CPU) 103a, communication signal processing resources such as digital signal processor (DSP) 103b, graphics processing unit (GPU) 103c, and hardware acceleration (HA) unit 103d. In some embodiments, the hardware acceleration (HA) unit 103d may establish direct memory access (DMA) sessions to route network traffic to various elements within electronic device 100 without direct involvement from processor 102 and/or operating system 124.

Processor 102 can, in some embodiments, include image signal processors (ISPs) (not shown) and dedicated artificial intelligence (AI) engines 105. Processor 102 is communicatively coupled to storage device 104, system memory 120, input devices (introduced below), output devices, including integrated display 130, and image capture device (ICD) controller 134.

According to one or more embodiments, ICD controller 134 performs or supports functions such as, but not limited to, selecting and activating an active camera from among multiple cameras and adjusting the camera settings and characteristics (e.g., shutter speed, f/stop, ISO exposure, zoom control, field of view (FOV) angle, etc.) of the active camera. ICD controller 134 can perform these functions in response to commands received from processor 102 in order to control ICDs 132, 133 to capture video or still images of a local scene within a FOV of the operating/active ICD. Throughout the disclosure, the term image capturing device (ICD) is utilized interchangeably to be synonymous with and/or refer to any one of front or rear facing cameras 132, 133. Front facing cameras 132 and rear facing cameras 133 are communicatively coupled to ICD controller 134, which is communicatively coupled to processor 102. Both sets of cameras 132, 133 include image sensors that can capture images that are within the field of view (FOV) of the respective ICD 132, 133.

In one or more embodiments, the functionality of ICD controller 134 is incorporated within processor 102, eliminating the need for a separate ICD controller. Thus, for simplicity in describing the features presented herein, the various camera selection, activation, and configuration functions performed by the ICD controller 134 are described as being provided generally by processor 102. Similarly, manipulation of captured images and videos are typically performed by GPU 103c and certain aspects of device communication via wireless networks are performed by DSP 103b, with support from CPU 103a. However, for simplicity in describing the features of the disclosure, the functionality provided by one or more of CPU 103a, DSP 103b, GPU 103c, and ICD controller 134 are collectively described as being performed by processor 102. Collectively, components integrated within processor 102 support computing, classifying, processing, transmitting and receiving of data and information, and presenting of graphical images within a display. Processor 102 can also be generally referred to as a controller.

System memory 120 may be a combination of volatile and non-volatile memory, such as random-access memory (RAM) and read-only memory (ROM). System memory 120 can store program code or similar data associated with firmware 122, an operating system 124, and/or applications 126. During device operation, processor 102 processes program code of the various applications, modules, OS, and firmware, that are stored in system memory 120.

In accordance with one or more embodiments, applications 126 include, without limitation, two-factor authentication readiness (2FAR) control module 152, banking application 154, a virtual private network (VPN) application 156, an ecommerce application 157, and communication module 158. Each module and/or application provides program instructions/code that are processed by processor 102 to cause processor 102 and/or other components of electronic device 100 to perform specific operations, as described herein. Descriptive names assigned to these modules add no functionality and are provided solely to identify the underlying features performed by processing the different modules. For example, 2FAR 152 includes program instructions that support electronic device 100 being configured to: detect a potential two-factor authentication (2FA) condition; detect a 2FA readiness status of a receiving device to receive and present 2FA information; and in response to identifying the 2FA readiness status of the receiving device as not ready, display an alert on the display of the electronic device. Thus, in one or more embodiments, 2FAR 152 can serve to enhance the effectiveness of two-factor authentication using electronic device 100 and reduce the instances when 2FA cannot be timely completed due to the receiving device not being ready. In addition to the modules/applications shown at (152-158), the electronic device 100 may also include a database 167 stored within the device 100, where the database 167 includes one or more tables that includes fields associated with two-factor authentication. The database 167 may be used by the 2FAR 152.

In one or more embodiments, electronic device 100 includes removable storage device (RSD) 136, which is inserted into RSD interface 138 that is communicatively coupled via system interlink to processor 102. In one or more embodiments, RSD 136 is a non-transitory computer program product or computer readable storage device. RSD 136 may have a version of one or more of the applications (e.g., 152, 154, 156, 157, 158) and specifically 2FAR 152 stored thereon. Processor 102 can access RSD 136 to provision electronic device 100 with program code that, when executed/processed by processor 102, the program code causes or configures processor 102 and/or generally electronic device 100, to provide the various two-factor authentication readiness check functions described herein.

Electronic device 100 includes an integrated display 130 which incorporates a tactile, touch screen interface 131 that can receive user tactile/touch input. As a touch screen device, integrated display 130 allows a user to provide input to or to control electronic device 100 by touching features within the user interface presented on display 130. Tactile, touch screen interface 131 can be utilized as an input device. The touch screen interface 131 can include one or more virtual buttons, indicated generally as 107b. In embodiments, when a user applies a finger on the touch screen interface 131 in the region demarked by the virtual button 107b, the touch of the region causes the processor 102 to execute code to implement a function associated with the virtual button. In some implementations, integrated display 130 is integrated into a front surface of electronic device 100 along with front ICDs, while the higher quality ICDs are located on a rear surface.

Electronic device 100 can further include microphone 108, one or more output devices such as speakers 144, and one or more input buttons 107a-107n. Microphone 108 can also be referred to as an audio input device. In some embodiments, microphone 108 may be used for identifying a user via voiceprint, voice recognition, and/or other suitable techniques. Input buttons 107a-107n may provide controls for volume, power, and ICDs 132, 133. Additionally, electronic device 100 can include input sensors 109 (e.g., enabling gesture detection by a user).

Electronic device 100 further includes haptic touch controls 145, vibration device 146, fingerprint/biometric sensor 147, global positioning system (GPS) device 160, and motion sensor(s) 162. Vibration device 146 can cause electronic device 100 to vibrate or shake when activated. Vibration device 146 can be activated during an incoming call or message in order to provide an alert or notification to a user of electronic device 100. According to one aspect of the disclosure, integrated display 130, speakers 144, and vibration device 146 can generally and collectively be referred to as output devices.

Biometric sensor 147 can be used to read/receive biometric data, such as fingerprints, to identify or authenticate a user. In some embodiments, the biometric sensor 147 can supplement an ICD (camera) for user detection/identification.

GPS device 160 can provide time data and location data about the physical location of electronic device 100 using geospatial input received from GPS satellites. Motion sensor(s) 162 can include one or more accelerometers 163 and gyroscope 164. Motion sensor(s) 162 can detect movement of electronic device 100 and provide motion data to processor 102 indicating the spatial orientation and movement of electronic device 100. Accelerometers 163 measure linear acceleration of movement of electronic device 100 in multiple axes (X, Y and Z). Gyroscope 164 measures rotation or angular rotational velocity of electronic device 100. Electronic device 100 further includes a housing 137 (generally represented by the thick exterior rectangle) that contains/protects the components internal to electronic device 100.

Electronic device 100 also includes a physical interface 165. Physical interface 165 of electronic device 100 can serve as a data port and can be coupled to charging circuitry 135 and device battery 143 to enable recharging of device battery 143.

Electronic device 100 further includes wireless communication subsystem (WCS) 142, which can represent one or more front end devices (not shown) that are each coupled to one or more antennas 148. In one or more embodiments, WCS 142 can include a communication module with one or more baseband processors or digital signal processors, one or more modems, and a radio frequency (RF) front end having one or more transmitters and one or more receivers. Example communication module 158 within system memory 120 enables electronic device 100 to communicate with wireless communication network 132 and with other devices, such as server 175, via one or more of data, audio, text, and video communications. Communication module 158 can support various communication sessions by electronic device 100, such as audio communication sessions, video communication sessions, text communication sessions, exchange of data, and/or a combined audio/text/video/data communication session.

WCS 142 and antennas 148 allow electronic device 100 to communicate wirelessly with wireless communication network 132 via transmissions of communication signals to and from network communication devices, such as base stations or cellular nodes, of wireless communication network 132. Wireless communication network 132 further allows electronic device 100 to wirelessly communicate with server 175, which can be similarly connected to wireless communication network 132. In one or more embodiments, the financial and other transactions that are being performed on communications device 100 can be supported using or completed via/on server 175.

Electronic device 100 can also wirelessly communicate, via wireless interface(s) 178, with wireless communication network 132 via communication signals transmitted by short range communication device(s) to and from an external WiFi router (or wireless transceiver device) 180, which is communicatively connected to wireless communication network 132. Wireless interface(s) 178 can be a short-range wireless communication component providing Bluetooth, near field communication (NFC), and/or wireless fidelity (Wi-Fi) connections. In one embodiment, electronic device 100 can receive Internet or Wi-Fi based calls, text messages, multimedia messages, and other notifications via wireless interface(s) 178. In one or more embodiments, electronic device 100 can communicate wirelessly with external wireless device 166, such as a WiFi router or BT transceiver, via wireless interface(s) 178. In an embodiment, WCS 142 with antenna(s) 148 and wireless interface(s) 178 collectively provide wireless communication interface(s) of electronic device 100.

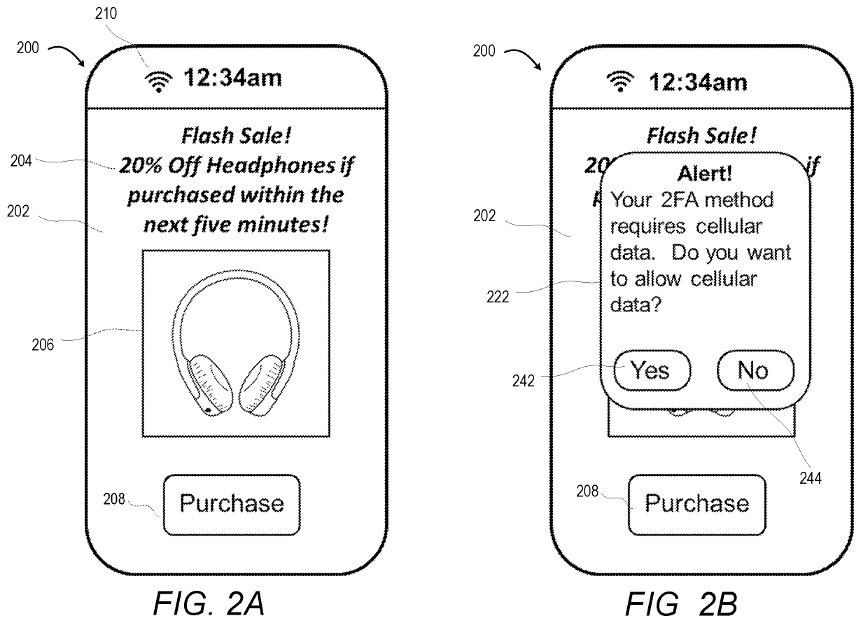

FIG. 2A is a diagram illustrating an example of a flash sale offer. FIG. 2A includes electronic device 200, which can be an implementation of electronic device 100, having similar components and/or functionality. Device 200 includes display 202. Rendered on display 202 is a flash sale offer 204 for a set of headphones, which is rendered on display 202 as image 206. A purchase button 208 is also rendered on display 202. When the purchase button 208 is tapped, clicked, or otherwise invoked, the selection of the button starts a transaction process. As can be seen in the flash sale offer 204, there is a limited time (e.g., five minutes) in which to complete the transaction. Connection status icon 210 indicates that the device 200 is currently connected via WiFi.

FIG. 2B is a diagram illustrating an example of a two-factor authentication alert for the flash sale offer referenced in FIG. 2A, according to one or more embodiments. In one or more embodiments, the processor of device 200 detects the invocation of the purchase button 208, and in response to detecting the invocation of the purchase button 208, performs a potential 2FA detection process. The potential 2FA detection process can include identifying an application (app) on the device 200 and/or a webpage displayed on a browser application on the device 200 as potentially required to complete the transaction and as being associated with a 2FA method. In one or more embodiments, a database (167 of FIG. 1) stored within the device 200 includes one or more tables that includes fields associated with two-factor authentication. The fields can include, but are not limited to, an application name, a website URL, a 2FA method, a 2FA network interface, a 2FA application, a VPN application, a 2FA receiving device, and so on. According to one or more embodiments, the fields of the database (167 of FIG. 1) can also provide a listing of identifying applications, websites, operation types, and/or accounts that may require 2FA. The 2FA method can include, but is not limited to, an SMS text message, an email, a voice call, an authenticator app response, and so on. The 2FA network can include cellular, WiFi, Bluetooth, and so on. In embodiments, the information in this database (167 of FIG. 1) may be entered by a user, retrieved from a website, and/or other suitable technique. In one or more embodiments, the database can be dynamically generated and/or periodically updated by an AI engine (105 of FIG. 1) tracking the different invocations of 2FA occurring on the device. In one or more embodiments, when an app or website that may require 2FA is loaded/activated, the processor checks the readiness status of a 2FA receiving device. In response to identifying the 2FA readiness status of the receiving device as not ready, the processor causes display of an alert 222 on the display 202 of the electronic device. In the example shown in FIG. 2A and FIG. 2B, the alert 222 indicates that the 2FA method in use requires a cellular connection. In this example, the single device 200 is the device used for the purchase transaction and is also the 2FA receiving device. The processor of device 200 detects that cellular data is required, based on information in the database. Thus, the alert 222 further includes button 242 to enable the cellular data on the device 200. Alternatively, button 244 can clear the alert 222 without enabling cellular data on the device 200. Accordingly, as shown in FIG. 2B, disclosed embodiments provide an alert, prior to attempting a transaction that requires 2FA. The alert informs the user to confirm the readiness status of the 2FA receiving device before attempting to perform a transaction.

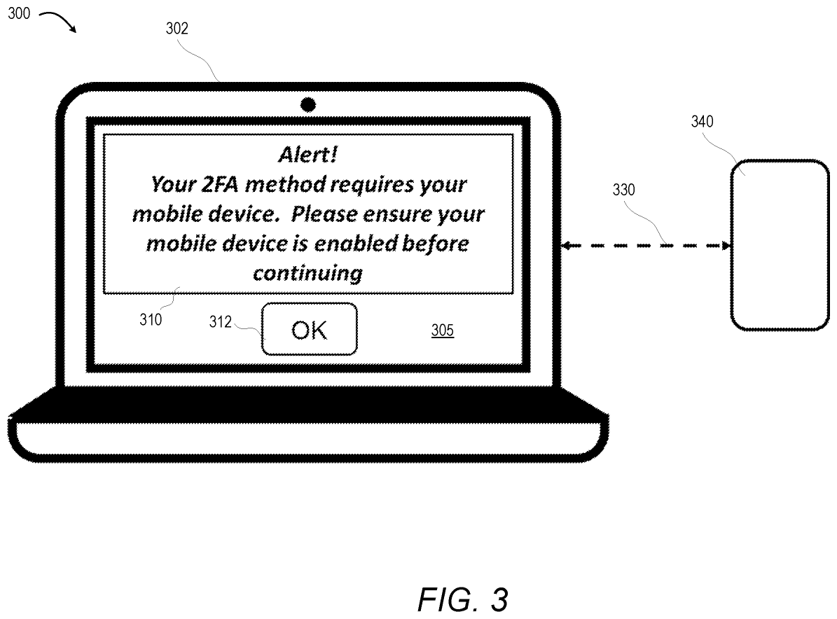

FIG. 3 is a diagram 300 illustrating an example of a notification, presented on a second electronic device, to alert a user having access to or utilizing the second electronic device to ready a portable electronic communication device for two-factor authentication, according to one or more embodiments. In the example shown in FIG. 3, device 340 is a mobile device, which can be an implementation of electronic device 100, having similar components and/or functionality. Device 302 is another electronic device, which can be a laptop computer, tablet computer, desktop computer, or other suitable type of device. Device 302 may be connected to device 340 via connection 330, which can be a wired or wireless connection. The wireless connection can include a Bluetooth connection, WiFi connection, or other suitable type of connection. In one or more embodiments, the WiFi connection can be an ad hoc connection via the Automatic Private IP Addressing (APIPA) protocol.

In the example depicted in FIG. 3, the device 302 is the device used for performing the transaction, while the device 340 is used for receiving 2FA information. The terms ‘first device’ and ‘second device’ are meant to denote two different devices, but either the first device or the second device can be the 2FA receiving device and/or the transaction device. The 2FA information can include an SMS text message, email, and/or output from an authenticator application. An authenticator app is a software application designed to enhance the security of online accounts by implementing two-factor authentication (2FA) or multi-factor authentication (MFA). The purpose of an authenticator app is to provide an additional layer of security beyond just a username and password. An authenticator app may be associated to an account via a QR code that is scanned by a camera of the 2FA receiving device, entering of a secret key, or other suitable technique, as part of an initial setup of the application. Once the authenticator app is set up with the shared secret, the authenticator app uses this secret along with the current time to generate a time-based one-time passcode (OTP). The OTP has a limited lifetime, which in embodiments, can range from 20 seconds to 60 seconds. In this way, even if a username and password are compromised, access to the 2FA receiving device is still required in order to gain account access, thereby improving security of the account. As previously stated, one challenge with these authentication systems is that if the 2FA receiving device is offline, or otherwise not currently enabled for receiving the 2FA information, the not-ready status of the 2FA receiving device can disrupt/prevent the transaction (e.g., purchase, login, etc.) that the user is attempting. Moreover, if the attempt is aborted due to lack of 2FA information, the user may miss a time-bound opportunity, such as a flash sale, auction bid, or the like. In one or more embodiments, a processor within device 302 performs a connection test (e.g., via ICMP ‘ping’ protocol, or other suitable technique) to determine if device 340 (the 2FA receiving device) is connected. In response to determining that the receiving device is offline (not connected to device 302), an alert 310 is rendered on the display 305 of device 302. In the scenario depicted in FIG. 3, the 2FA receiving device (340) is a different device than the transaction device (302), in contrast to the example depicted in FIG. 2A and FIG. 2B, in which the transaction device and 2FA receiving device were the same device. Once the user has enabled the device 340, the user can invoke button 312 to proceed with the transaction. Accordingly, the transaction can succeed since the user has ensured that the device 340 is 2FA ready (i.e., powered on, connected, etc.).

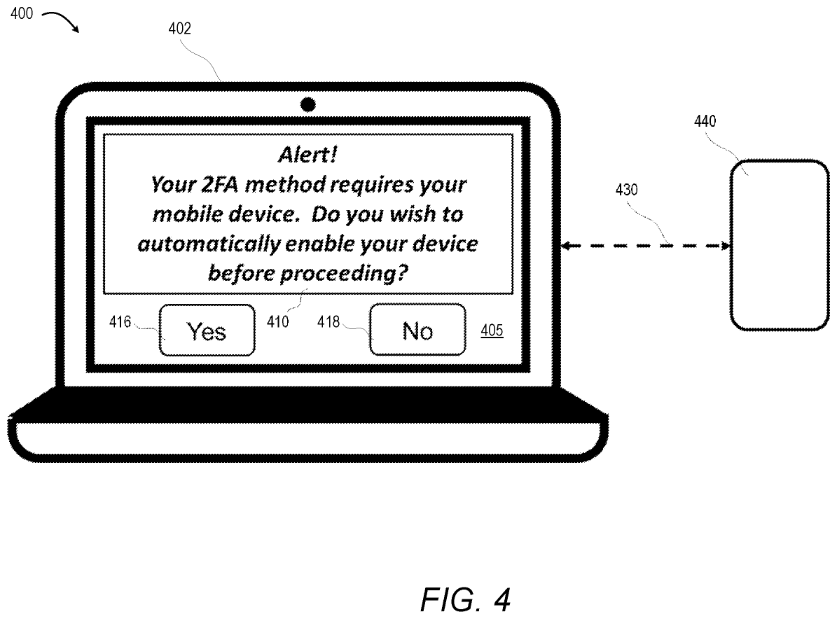

FIG. 4 is a diagram 400 illustrating an example of a notification presented on a display of an electronic device to automatically enable a portable electronic communication device for two-factor authentication, according to one or more embodiments. In one or more embodiments, the generation of a notification can be accomplished via a local connection, such as a Bluetooth connection between two devices. The local connection enables communication, such as messaging, or API calls to enable transferring of information, including, e.g., a one-time passcode (OTP), from one device to another. In the example shown in FIG. 4, device 440 is a mobile device, which can be an implementation of electronic device 100, having similar components and/or functionality. Device 402 is a second electronic device, which can be a laptop computer, tablet computer, desktop computer, or other suitable type of device. Device 402 may be connected to device 440 via connection 430, which can be a wired or wireless connection as previously described. The scenario depicted in FIG. 4 is similar to that depicted in FIG. 3, with one difference being that in the scenario depicted in FIG. 4, device 440 is connected to device 402 via connection 430, where connection 430 is a local network connection rather than a cellular or other non-local network connection. The local network connection can be a Bluetooth connection, WiFi connection, infrared connection, wired serial connection (e.g., via USB cable), or other suitable connection type. Accordingly, device 402 can communicate with device 440 and determine the 2FA readiness status of device 440. In one or more embodiments, the determination of 2FA readiness status of device 440 can be determined via executing one or more application programming interface (API) calls provided by device 440, connecting from device 402 to device 440 via a connection protocol (e.g., telnet, SSH, or the like), and/or other suitable techniques. Moreover, the device 440 may expose API calls for another device, such as device 402, to perform querying and/or enabling the device 440 for 2FA readiness. These API calls can include, but are not limited to, an API call to configure the device 440 to disable airplane mode, an API call to enable a specific network interface (e.g., cellular network), and/or invocation of a specific application on device 440, such as an authenticator application.

In response to determining that the 2FA receiving device 440 is not ready (e.g., a required network interface is not enabled or the device 440 is in airplane mode (with most required communication radios disabled)), an alert 410 is rendered on the display 405 of device 402. In the scenario depicted in FIG. 4, the 2FA receiving device (440) is reachable by the transaction device (402), in contrast to the example depicted in FIG. 3 where the 2FA receiving device 340 is offline. Accordingly, transaction device 402 provides a button 416 to allow the receiving device 440 to be enabled from the transaction device 402. Thus, embodiments can include determining that the communication channel associated with the 2FA condition is a cellular network and sending a command to the second electronic device to enable a cellular network interface on the second electronic device. In the presented embodiment, a button 418 is also provided to allow the alert 410 to be cleared without enabling the device 440 to receive 2FA information. In one or more embodiments, to detect the 2FA readiness status, the processor configures the electronic device to: identify, as the receiving device, a second electronic device that is an authenticator device for the potential 2FA condition; connect to the second electronic device via a local network; and query the second electronic device to determine a status of a communication channel associated with the potential 2FA condition.

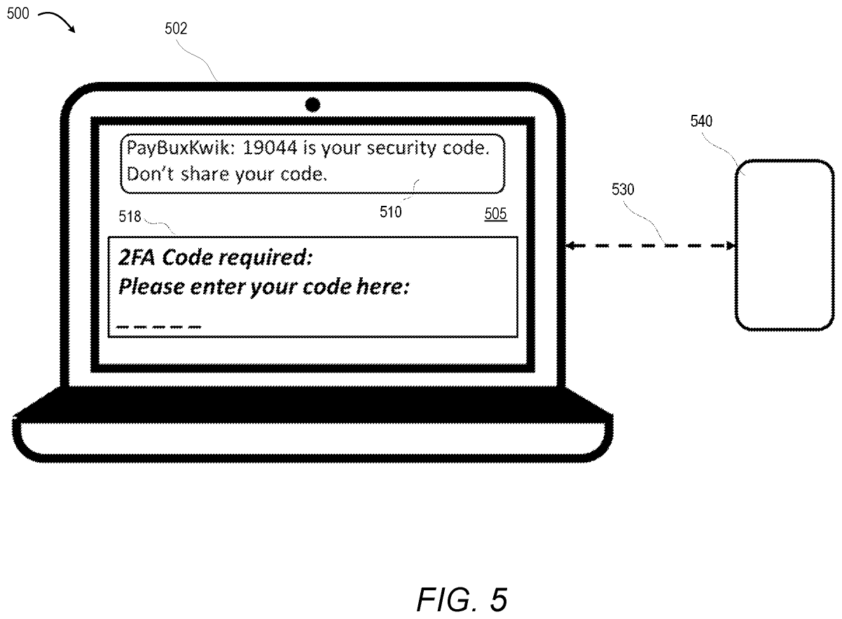

FIG. 5 is a diagram 500 illustrating an example of retrieving a one-time passcode from a portable electronic communication device for use in two-factor authentication, according to one or more embodiments. FIG. 5 continues from the example shown in FIG. 4. In the example shown in FIG. 5, device 540 is a mobile device, which can be an implementation of electronic device 100, having similar components and/or functionality. Device 502 is a second electronic device similar to device 402 of FIG. 4. Device 502 may be connected to device 540 via connection 530, which can be a wired or wireless connection as previously described. According to one aspect of the disclosure, since the transaction device 502 has a connection to 2FA receiving device 540, the transaction device 502 can directly retrieve an OTP from the 2FA receiving device 540 via connection 530 and display the OTP on the display 505 of the transaction device 502, as shown with message 510. In one or more embodiments, the display of the OTP can be performed using screen mirroring, screen casting, or retrieving the OTP via a message sent from the 2FA receiving device 540 to the transaction device 502 via a communication protocol, such as TCP (Transmission Control Protocol), or the like. The user can then conveniently enter the OTP in the 2FA dialog box 518 that is rendered on display 505 of transaction device 502. Accordingly, the transaction can succeed since the user has ensured that the device 540 is 2FA ready (required network access enabled, etc.) and acquire the required 2FA data without the user having to access the 2FA receiving device 540.

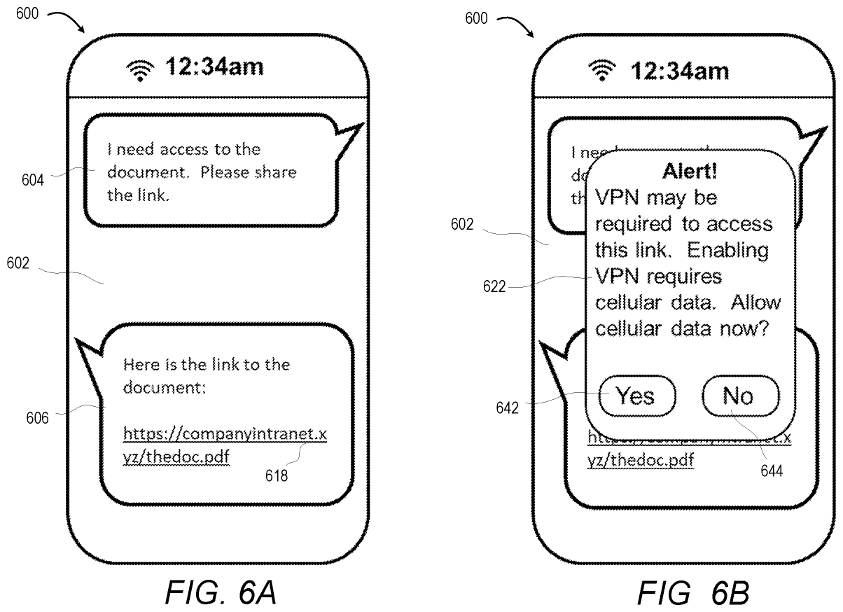

FIG. 6A is a diagram illustrating an example of sharing a secure URL (uniform resource locator) using a portable electronic communication device. FIG. 6A includes electronic device 600, which can be an implementation of electronic device 100, having similar components and/or functionality. Device 600 includes display 602. Rendered on display 602 is a copy of a first message 604 that was sent from device 600 to a second device to request access to a digital asset. The digital asset can include a file, a stream, a URL (uniform resource locator), or other digital asset. A second message 606 is received by device 600 from another electronic device and provides a link 618 to the requested digital asset. A common scenario for the use case depicted in FIG. 6A is where two employees are attempting to share a document on their company intranet. Typically, documents on a company intranet can require connection via VPN in order to access those documents. In one or more embodiments, upon receiving second message 606, a processor within device 600 attempts an access request for the link 618. In one or more embodiments, the access test can include sending an HTTP request to a server associated with the link 618. The association of the server can include a DNS lookup process to determine an internet protocol (IP) address from a domain name. The processor checks for a successful response to the access request (e.g., an HTTP code 200 received from the server). If no response is received from the server, the processor may infer that the network is currently unreachable. This is a scenario that can frequently occur when users are sharing documents that are stored on a protected network such as a company intranet that requires VPN (virtual private network) access. In response to determining that the server associated with the link 618 is unreachable, the processor can invoke a VPN alert, as further explained and shown in FIG. 6B.

FIG. 6B is a diagram illustrating an example of providing an alert to a user of a device to prepare a portable electronic communication device for two-factor authentication in order to obtain VPN (virtual private network) access for the secure URL shown in FIG. 6A, according to one or more embodiments. Continuing from the example depicted in FIG. 6A, FIG. 6B shows an alert 622 rendered on display 602 of device 600, indicating (based on the link 618 being unreachable) that VPN access may be required. The processor further determines that the 2FA receiving requirements for enabling VPN access are not currently met. The alert 622 thus includes ‘Yes’ button 642 to enable a user to put the device 600 in a 2FA ready state. The alert 622 further includes button 644 to allow a user to clear the alert 622 without performing the 2FA readiness steps. A scenario where a user may opt to select ‘No’ button 644 can include when the user is in a roaming area where cellular usage is expensive, or if the user is currently in an area where cellular reception is not possible (e.g., an underground basement). With the above disclosed embodiments, sharing of digital assets on protected networks is streamlined by ensuring that 2FA receiving devices associated with VPNs are ready, to enable successful joining of a VPN needed to access a given digital asset.

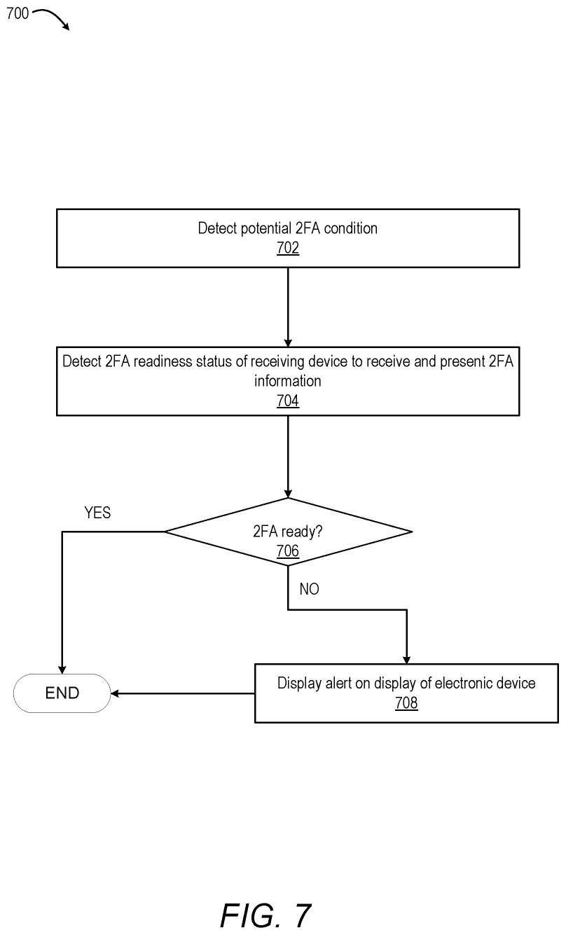

Referring now to the flow charts presented by FIGS. 7-12, the descriptions of the methods in FIGS. 7-12 are provided with general reference to the specific components and features illustrated within the preceding FIGS. 1-6. Specific components referenced in the methods of FIGS. 7-12 may be identical or similar to components of the same name used in describing preceding FIGS. 1-6. In one or more embodiments, processor 102 (FIG. 1) configures electronic device 100 (FIG. 1) to provide the described functionality of the methods of FIGS. 7-12 by executing program code for one or more modules or applications provided within system memory 120 of electronic device 100.

FIG. 7 depicts a flowchart of a method 700 for generating alerts regarding a status of a portable communication device for enabling an upcoming two-factor authentication transaction at the portable communication device, according to one or more embodiments. At block 702, a potential 2FA condition is detected. A 2FA condition can include a condition in which an OTP is required to complete a transaction, such as a purchase, logon to an online account, and/or other type of transaction requiring two-factor authentication. In one or more embodiments, the detection of a potential 2FA condition can be based on identifying an active application executing in the foreground on an electronic device for which a transaction is to be performed. The transaction can include logging into an account that requires two-factor authentication. In some embodiments, the detection of a potential 2FA condition can be based on detecting loading of a webpage for which a transaction is to be performed. The webpage is loaded into a browser on an electronic device. At block 704, a 2FA readiness status of a 2FA receiving device is detected. In scenarios where the receiving device is the same as the transaction device (such as depicted in FIG. 2A and FIG. 2B, and FIG. 6A and FIG. 6B), this can include a processor on the transaction/receiving device retrieving 2FA information from a database, where the 2FA indicates a required connection type (e.g., cellular, WiFi), as well as other requirements, such as general internet access, VPN access, and so on. In scenarios where the receiving device and transaction device are different devices (such as depicted in FIG. 3, FIG. 4, and FIG. 5), the process can include the transaction device querying the 2FA receiving device via a connection such as a local network. If, at block 706, it is determined that the receiving device is ready to receive 2FA information, the method 700 ends. If instead, at block 706, it is determined that the receiving device is not ready to receive 2FA information, then the method 700 continues to block 708, where an alert is displayed on the display of the electronic device (e.g., 222 of FIG. 2B). The method 700 then ends.

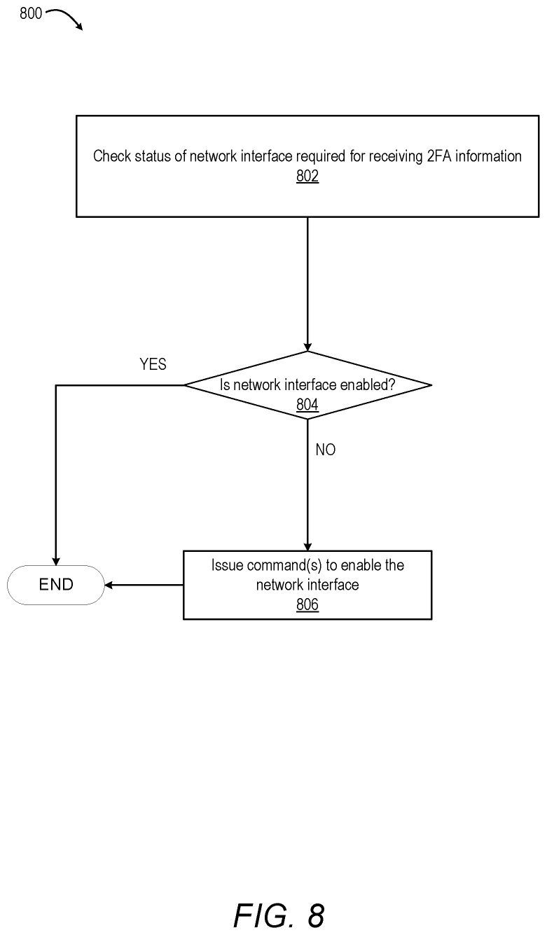

FIG. 8 depicts a flowchart of a method 800 for checking if a network interface required for receiving two-factor authentication information is enabled, according to one or more embodiments. At block 802, a check of status for a network interface required for receiving 2FA information is performed. If, at block 806, the network interface is already enabled, the method 800 ends. If, at block 804, it is determined that a network interface required for receiving 2FA information is not enabled, the method 800 continues to block 806, where the one or more commands are issued to enable the network interface on the 2FA receiving device. Then the method 800 ends. The enabling of the network interface can include issuing one or more commands to the 2FA receiving device to enable physical interfaces such as one or more radios, as well as interacting with an operating system kernel to load drivers, and enable logical network interfaces. Thus, embodiments can include, in response to determining that a network interface required for receiving the 2FA information is not enabled, transmitting one or more commands to enable the network interface on the second electronic device to allow receipt of the 2FA information.

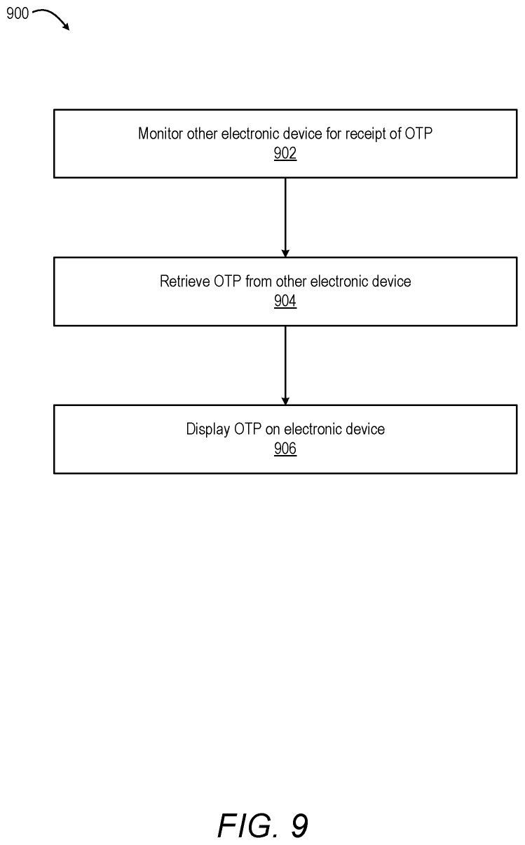

FIG. 9 depicts a flowchart of a method 900 for receiving a one-time passcode (OTP) from a second electronic communication device and displaying the OTP on a first electronic communication device, according to one or more embodiments. At block 902, another electronic device is monitored for receipt of a one-time passcode (OTP). The method 900 continues with retrieving the OTP from the other electronic device at block 904, and displaying the retrieved OTP on the electronic device at block 906. The features provided by method 900 enable convenient two-factor authentication by ensuring that the 2FA receiving device is ready before the transaction proceeds, and then further provides additional convenience by retrieving the OTP from the 2FA receiving device and displaying it on the transaction device. Examples of method 900 are shown in at least FIG. 4 and FIG. 5. Thus, embodiments can include: monitoring the second electronic device for receipt of a one-time passcode (OTP) on the second electronic device; retrieving the OTP from the second electronic device, the OTP being identified as the 2FA information received by the second electronic device to complete the 2FA condition; and displaying the OTP on the display of the electronic device.

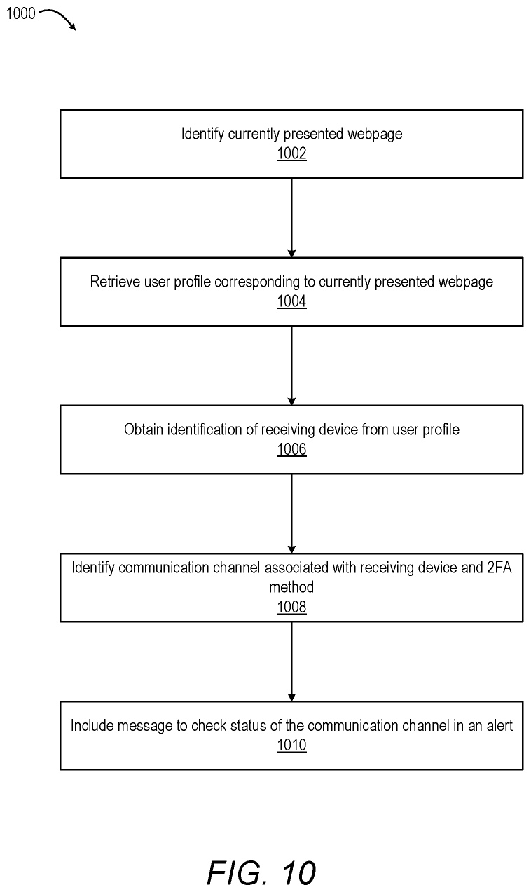

FIG. 10 depicts a flowchart of a method 1000 by which an electronic communication device includes a 2FAR control module to identify a communication channel associated with a two-factor authentication method, based on a user profile, according to one or more embodiments. At block 1002, a currently presented webpage is identified. This can include identifying a URL of the webpage currently rendered in a browser application executing on an electronic device. The method 1000 continues to block 1004, where a user profile corresponding to the currently presented webpage is retrieved. In one or more embodiments, the user profile can include a username, a unique identifier (e.g., telephone number, MAC address, etc.) associated with a 2FA receiving device, a 2FA method, and/or a communication channel associated with the 2FA receiving device and 2FA method. The method 1000 continues to block 1006 where the 2FA receiving device is identified from the user profile. The method 1000 then continues to block 1008 where a communication channel associated with the receiving device and 2FA method is identified. In embodiments, the communication channel can include a cellular network. The method 1000 then continues to block 1010, where a message to check the status of the communication channel is included in an alert. Examples of such messages are shown in at least FIG. 2B, FIG. 3, FIG. 4, and FIG. 6B. Thus, embodiments can include: identifying a currently presented webpage on the display of the electronic device as potentially requiring 2FA; and retrieving a user profile corresponding to the currently presented webpage, where the user profile contains a 2FA configuration. The 2FA configuration can include a list of resources required to complete a two-way authentication action. The resources listed in the 2FA configuration can include a service provider, communication channel, network interface, authentication application, and so on. Embodiments can further include: obtaining an identification of the receiving device from the user profile; identifying a communication channel associated with the receiving device and the 2FA method; and including in the alert, a message to check the status of at least the identified communication channel.

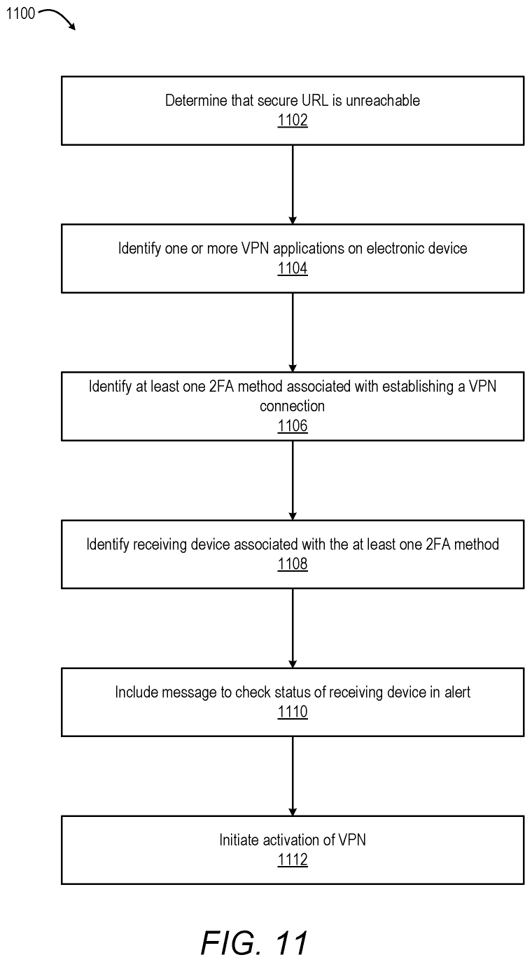

FIG. 11 depicts a flowchart of a method 1100 for generating an alert based on checking a 2FA readiness status of a receiving device associated with a VPN, according to one or more embodiments. At block 1102, the method 1100 includes determining that a secure URL is unreachable. In one or more embodiments, the determination can include performing an ICMP (ping) operation on an address associated with the secure URL, and/or performing an HTTP access request for a resource associated with the secure URL. The method 1100 continues to block 1104, where one or more VPN applications are identified on the electronic device. The method 1100 continues to block 1106, where at least one 2FA method associated with establishing a VPN connection is identified. The method 1100 continues to block 1108, wherein a 2FA receiving device associated with the at least one 2FA method is identified. The method 1100 then includes displaying an alert that includes a message to check the status of and/or ready the 2FA receiving device at block 1110. Examples of such messages are shown in at least FIG. 3 and FIG. 6B. The method 1100 then includes initiating activation of a VPN at block 1112. Embodiments can include: determining that a secure URL is currently unreachable by the electronic device; identifying one or more available virtual private network (VPN) applications on the electronic device; identifying at least one 2FA method associated with establishing a VPN utilizing at least one of the one or more available VPN applications; identifying the receiving device associated with the at least one 2FA method; including in the alert, a message to check the status of the identified receiving device and the identified VPN; and initiating an activation of the identified VPN. Thus, disclosed embodiments enable a more seamless way to access secure digital assets.

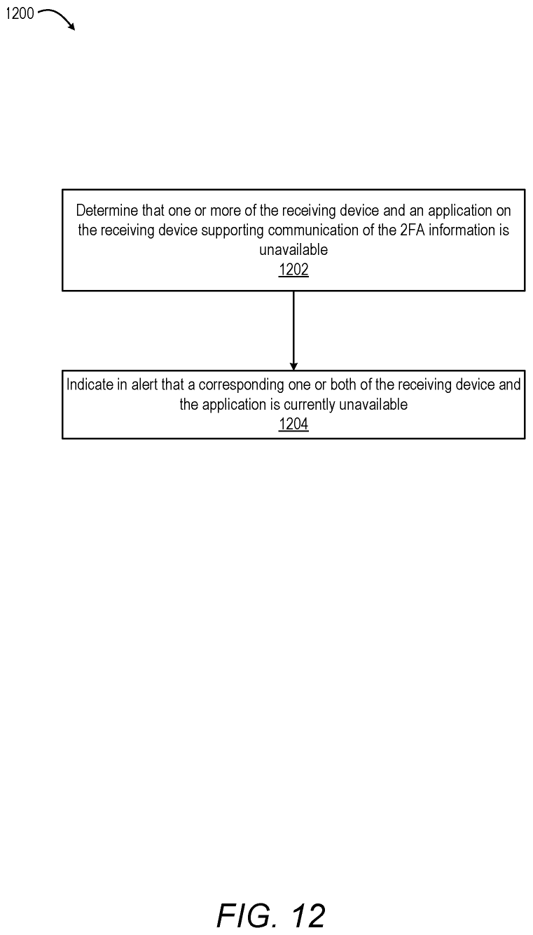

FIG. 12 depicts a flowchart of a method 1200 for indicating, within an alert, that a receiving device or an application required for two-factor authentication is unavailable, according to one or more embodiments. At block 1202, a determination is made that one or more of the 2FA receiving device and an application on the receiving device that supports communication of 2FA information is unavailable. As an example, the 2FA receiving device can be available, but a required authentication application might not be currently installed on the 2FA receiving device. The method 1200 continues to block 1204, where an alert is displayed that indicates one or both of the receiving device is currently unavailable and/or the application is currently unavailable. Thus, embodiments can include: determining that one or more of the receiving device and an application on the receiving device supporting communication of the 2FA information is unavailable; and indicating, within the alert that is displayed on the display, that a corresponding one or both of the receiving device and the application is currently unavailable.

As can now be appreciated, the disclosed embodiments provide improved two-factor authentication. These improvements can be particularly useful for flash sales and other time bound activities. Customers who miss out on a flash sale due to the short timeframe might feel frustrated or disappointed. This negative experience can impact their perception of the brand. Disclosed embodiments promote convenient and secure access to online accounts, which is of paramount importance for various reasons. These reasons can include protecting personal information and preventing identity theft. Online accounts often contain sensitive personal information, such as financial data, personal correspondence, health records, and more. Secure access ensures that this information remains private and is not exposed to unauthorized individuals. Furthermore, Cybercriminals can exploit weak security to steal personal data and use it for identity theft. Secure access methods like two-factor authentication (2FA) can make it significantly more difficult for attackers to impersonate a user. Accordingly, the disclosed embodiments improve the technical field of online account access by providing a combination of convenience and security in accessing online accounts that provides individuals and businesses with the ability to harness the benefits of time bound activities such as flash sales, online auctions, and other limited-time offers, while safeguarding their personal and sensitive information from malicious actors.

In the above-described methods, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals, but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

What is claimed is:

1. An electronic device comprising:
a display;
a memory having stored thereon at least one application and a two-factor authentication readiness (2FAR) control module;
a network interface which enables the electronic device to connect to, and exchange data with, at least one second electronic device; and
a processor communicatively coupled to the display, the memory, and the network interface, and which executes program code of the 2FAR control module, which enables the electronic device to:
detect a potential two-factor authentication (2FA) condition;
detect a 2FA readiness status of a receiving device to receive and present 2FA information; and
in response to identifying the 2FA readiness status of the receiving device as not ready, display an alert on the display of the electronic device.

2. The electronic device of claim 1, wherein to detect the 2FA readiness status, the processor configures the electronic device to:
identify, as the receiving device, a second electronic device that is an authenticator device for the potential 2FA condition;
connect to the second electronic device via a local network; and
query the second electronic device to determine a status of a communication channel associated with the potential 2FA condition.

3. The electronic device of claim 2, wherein further, the processor:
in response to determining that a network interface required for receiving the 2FA information is not enabled, enables the network interface on the second electronic device to allow receipt of the 2FA information.

4. The electronic device of claim 3, wherein to enable the network interface on the second electronic device, the processor:
determines that the communication channel associated with the potential 2FA condition is a cellular network; and
sends a command to the second electronic device to enable a cellular network interface on the second electronic device.

5. The electronic device of claim 3, wherein further, the processor:
monitors the second electronic device for receipt of a one-time passcode (OTP) on the second electronic device;
retrieves the OTP from the second electronic device, the OTP being identified as the 2FA information received by the second electronic device to complete the 2FA condition; and
displays the OTP on the display of the electronic device.

6. The electronic device of claim 2, wherein to detect a potential 2FA condition, the processor:
identifies a currently presented webpage on the display of the electronic device as potentially requiring 2FA; and
retrieves a user profile corresponding to the currently presented webpage, wherein the user profile contains a 2FA configuration.

7. The electronic device of claim 6, wherein the user profile further comprises an identification of the receiving device, and the processor:
identifies a communication channel associated with the receiving device and a 2FA method; and
includes in the alert, a message to check the status of at least the identified communication channel.

8. The electronic device of claim 1, wherein to detect a potential 2FA condition, the processor:
determines that a secure URL is currently unreachable by the electronic device;
identifies one or more available virtual private network (VPN) applications on the electronic device;
identifies at least one 2FA method associated with establishing a VPN utilizing at least one of the one or more available VPN applications;
identifies the receiving device associated with the at least one 2FA method;
includes in the alert, a message to check the status of the identified receiving device and the identified VPN; and
initiates an activation of the identified VPN.

9. The electronic device of claim 1, wherein to display an alert on the display of the electronic device, the processor:
determines that one or more of the receiving device and an application on the receiving device supporting the communication of the 2FA information is unavailable; and
indicates, within the alert that is displayed on the display, that a corresponding one or both of the second electronic device and the application is currently unavailable.

10. A method comprising:
detecting, by an electronic device comprising a display, a potential two-factor authentication (2FA) condition;
detecting a 2FA readiness status of a receiving device to receive and present 2FA information; and
in response to identifying the 2FA readiness status of the receiving device as not ready, displaying an alert on the display of the electronic device.

11. The method of claim 10, wherein detecting the 2FA readiness status further comprises:
identifying, as the receiving device, a second electronic device that is an authenticator device for the potential 2FA condition;
connecting to the second electronic device via a local network; and
querying the second electronic device to determine a status of a communication channel associated with the potential 2FA condition.

12. The method of claim 11, further comprising, in response to determining that a network interface required for receiving the 2FA information is not enabled, enabling the network interface on the second electronic device to allow receipt of the 2FA information.

13. The method of claim 12, wherein enabling the network interface further comprises:
determining that the communication channel associated with the 2FA condition is a cellular network; and
sending a command to the second electronic device to enable a cellular network interface on the second electronic device.

14. The method of claim 12, further comprising:
monitoring the second electronic device for receipt of a one-time passcode (OTP) on the second electronic device;
retrieving the OTP from the second electronic device, the OTP being identified as the 2FA information received by the second electronic device to complete the 2FA condition; and
displaying the OTP on the display of the electronic device.

15. The method of claim 11, wherein detecting a potential 2FA condition further comprises:
identifying a currently presented webpage on the display of the electronic device as potentially requiring 2FA; and
retrieving a user profile corresponding to the currently presented webpage, wherein the user profile contains a 2FA configuration.

16. The method of claim 15, further comprising:
obtaining an identification of the receiving device from the user profile;
identifying a communication channel associated with the receiving device and the 2FA method; and
including in the alert, a message to check the status of at least the identified communication channel.

17. The method of claim 10, wherein detecting a potential 2FA condition further comprises:
determining that a secure URL is currently unreachable by the electronic device;
identifying one or more available virtual private network (VPN) applications on the electronic device;
identifying at least one 2FA method associated with establishing a VPN utilizing at least one of the one or more available VPN applications;
identifying the receiving device associated with the at least one 2FA method;
including in the alert, a message to check the status of the identified receiving device and the identified VPN; and
initiating an activation of the identified VPN.

18. The method of claim 10, further comprising:
determining that one or more of the receiving device and an application on the receiving device supporting communication of the 2FA information is unavailable; and
indicating, within the alert that is displayed on the display, that a corresponding one or both of the receiving device and the application is currently unavailable.

19. A computer program product comprising a non-transitory computer readable medium having program instructions that when executed by a processor of an electronic device that comprises a display, the program instructions configure the electronic device to perform functions comprising:
detecting a potential two-factor authentication (2FA) condition;
detecting a 2FA readiness status of a receiving device to receive and present 2FA information; and
in response to identifying the 2FA readiness status of the receiving device as not ready, displaying an alert on the display of the electronic device.

20. The computer program product of claim 19, wherein the computer program product further comprises program instructions for:
determining that a secure URL is currently unreachable by the electronic device;
identifying one or more available virtual private network (VPN) applications on the electronic device;
identifying at least one 2FA method associated with establishing a VPN utilizing at least one of the one or more available VPN applications;
identifying the receiving device associated with the at least one 2FA method;
including in the alert, a message to check the status of the identified receiving device and the identified VPN; and
initiating an activation of the identified VPN.
